(19) United States
(12) Patent Application Publication
(10) Pub. No.: US 2025/0024988 A1
(43) Pub. Date: Jan. 23, 2025

(54) VESSEL AND A SYSTEM FOR MAKING A BEVERAGE

(71) Applicant: Chun Pong YIU, Hong Kong (CN)

(72) Inventor: Chun Pong YIU, Hong Kong (CN)

(21) Appl. No.: 18/223,180

(22) Filed: Jul. 18, 2023

(51) Int. Cl. A47J 31/54; A47J 31/46; A47J 31/52; A47J 45/06

(52) U.S. Cl. CPC A47J 31/54; A47J 31/461; A47J 31/521; A47J 45/067

(57) ABSTRACT

A system for a vessel comprising a vessel chamber arranged to store a beverage or a potable liquid; a spout portion arranged to communicate with the vessel chamber to release the beverage or the potable liquid from the vessel chamber; a valve assembly comprising a valve member movable between a first position and a second position, wherein the valve member at the first position permits a higher flow rate of the beverage or the potable liquid from the vessel chamber than the valve member at the second position; and a control member operable by the user to control the position of the valve member.

### TECHNICAL FIELD

The present invention relates to a vessel, and particularly, although not exclusively, to a pour over vessel. The present invention also relates to a system for making a beverage, in particular, but not limited to, a system for making a pour over hot beverage such as a coffee or tea.

### BACKGROUND

Coffee and tea are commonly made beverages. There are several commonly known devices and techniques for making coffee or tea using several devices. One technique of making these beverages involves brewing, in particular hand drip coffee brewing (also known as pour over) which is a technique for manually brewing coffee by hand.

Typically, hand drip apparatus includes a coffee dripper, a permanent filter or filter paper, a carafe or mug, a kettle, and optionally a coffee grinder for grounding coffee beans if coffee beans are used instead of pre-ground coffee beans. Water and other ground ingredients (e.g., ground coffee, etc.) are mixed in the coffee dripper and allowed to steep (i.e., brew) within the coffee dripper.

Prior to brewing, the coffee maker pours some hot water through the filter paper without ground ingredients so as to ensure proper drip speed. The water collected by the carafe or mug are then dumped out.

During brewing, water can be poured in a slow, circular motion in several rounds in controlled quantities. The first pour “the bloom” is performed by pouring a small amount of water just enough to saturate all the coffee grounds and create a bloom. A second pour is then performed by pouring in the centre and moving toward to the outside edge of the coffee ground. The third pour is then preformed by pouring from the outside in again.

The water flow rate is decisive in the preparation of a good tasting cup of hand drip coffee. A common problem experienced by existing hand drip coffee makers is that depending on the diameter of the spout and the degree of inclination of the kettle held by the coffee maker, a varied amount of hot water will be poured out from the spout. Such kettle designs are susceptible to burping spurts of water when the energy of the hot water in the kettle is released from the spout. In turn, the coffee is not brewed at an optimal water flow rate which may ruin the taste of the hand drip coffee.

Another challenge when using kettle (such as for example pour over kettle etc.) is making beverages correctly. Users can often find it difficult to determine the suitable brew time and flow rate for different species of coffee beans.

### SUMMARY OF THE INVENTION

The present invention relates to a beverage making device which in some embodiments, may overcome or substantially ameliorate at least some of the problems identified above or at least provide a useful alternative.

The present invention also relates to a method and system for making a beverage using the beverage making device.

In a first aspect the present invention relates to a vessel comprising:
a vessel chamber arranged to store a beverage or a potable liquid;
a spout portion arranged to communicate with the vessel chamber to release the beverage or the potable liquid from the vessel chamber;
a valve assembly comprising
   a valve member movable between a first position and a second position, wherein the valve member at the first position permits a higher flow rate of the beverage or the potable liquid from the vessel chamber than the valve member at the second position; and
   a control member operable by the user to control the position of the valve member.

In an embodiment of the first aspect, the expel of the beverage or the potable liquid is at a maximum flow rate when the valve member is at the first position.

In an embodiment of the first aspect, the expel of the beverage or the potable liquid is blocked by the valve member when the valve member is at the second position.

In an embodiment of the first aspect, the valve member is movable between multiple positions and adjustable by the user whereby the vessel is operable to expel the beverage or the potable liquid at various flow rates.

In an embodiment of the first aspect, the valve member includes a plug portion arranged to be movable in a direction substantially parallel to the flow direction of the beverage or the potable liquid at an inlet of the spout portion in communication with the vessel chamber.

In an embodiment of the first aspect, the plug portion includes a tapered portion.

In an embodiment of the first aspect, the control member is disposed outside the vessel chamber and accessible by the user on the outer wall of the vessel.

In an embodiment of the first aspect, the control member includes a push and pull button arranged such that the valve member is movable towards the inlet of the spout portion when the button is in a depressed position.

In an embodiment of the first aspect, the vessel further comprises a handle, and the control member is at a position proximate to the handle whereby the handle and the control member are both accessible by the same hand of the user.

In an embodiment of the first aspect, the valve assembly further includes a linkage with its one end connected to the valve member and the opposite end connected to the control member.

In an embodiment of the first aspect, at least a portion of the linkage is extended along a first direction being substantially parallel to the spout direction and extended further along a second direction being substantially perpendicular to the first direction.

In an embodiment of the first aspect, the vessel chamber further comprises a tubular member with an opening through which at least a portion of the control member disposed outside the vessel chamber is insertable into the vessel chamber.

In an embodiment of the first aspect, the valve assembly further includes a base member on which the valve member is mounted.

In an embodiment of the first aspect, the base member is slidably movable along the base of the vessel.

In a second aspect the present invention relates to a system for making a beverage or a potable liquid, the system comprising:
a vessel comprising:
   a vessel chamber arranged to store a beverage or a potable liquid;
   a spout portion arranged to communicate with the vessel chamber to release the beverage or the potable liquid from the vessel chamber;
   a valve assembly comprising
      a valve member movable between a first position and a second position, wherein the valve member at the first position permits a higher flow rate of the beverage or the potable liquid from the vessel chamber than the valve member at the second position; and
      a control member operable by the user to control the position of the valve member;
one or more sensors associated with the vessel, the sensors configured to determine information associated with the flow rate of the beverage or the potable liquid;
   a wireless communication transceiver configured to transmit signals from the one or more sensors;
   a mobile communication device comprising a processor, a memory, graphical user interface and a wireless communication interface;
   the mobile communication device configured to receive sensor readings from the one or more sensors wirelessly via the wireless communication interface.

In an embodiment of the second aspect, the system further comprises a motion sensor configured to determine one or more information associated with the position of the valve member relative to the spout portion.

In an embodiment of the second aspect, the system further comprises an indication unit configured to inform the user when the position of the valve member is offset from a referential valve position.

In an embodiment of the second aspect, the processor is configured to determine the optimal flow rate of the beverage or the potable liquid released from the spout portion associated with the making of a selected beverage.

In an embodiment of the second aspect, the mobile communication device further comprises an image capturing module configured to determine the identity of a selected beverage.

In an embodiment of the second aspect, the system further comprises an indication unit configured to inform the user upon the amount of the beverage or the potable liquid released from the spout portion within a predetermined period exceeds a predetermined volume threshold.

It should be understood that alternative embodiments or configurations may comprise any or all combinations of two or more of the parts, elements or features illustrated, described or referred to in this specification.

As used herein the term ‘and/or’ means ‘and’ or ‘or’, or where the context allows both.

As used herein “(s)” following a noun means the plural and/or singular forms of the noun.

In this specification the term “kettle” or “pour over kettle” refers to a beverage making devices that include a container and a spout portion through which liquid can be released from the vessel for mixing particulates (i.e. grounds or sediments) in a coffee dripper so as to prepare a drinkable beverage.

In this specification the term “particulates” refers to solids matter that is required to make a beverage such as for example tea leaves, ground coffee beans, lemon slices, fruit slices or other solids that are steeped within liquid.

In this specification the term “beverage” includes both the liquid used to make the beverage (e.g. water, milk, juice, coffee, sports drinks, soda water, mineral water, tea pre-brewed drinks, partially brewed drinks) as well as the end beverage product (such as coffee, tea, juice, fused water, alcoholic drinks, etc) consumed by a user. The term “beverage” is also defined to include water, including tap water, mineral water, filtered water, town water or bottled water.

In this specification the term “potable liquid” includes any consumable drinks or potable water with a quality suitable for consumption, drinking, brewing or cooking such as tap water, reverse osmosis water, deionized water, alkaline water, mineral or sparkling water, spring water, well water, brine or salty water. Also, it is noted that at least some embodiments may be described as a method (i.e. process) that is depicted as a flowchart, a flow diagram, a structure diagram, or a block diagram. Although a flowchart may describe the operations as a sequential method, many of the operations can be performed in parallel or concurrently. In addition, the order of the operations may be rearranged. A method (i.e. process) is terminated when its operations are completed.

In this specification, the word “comprising” and its variations, such as “comprises”, has its usual meaning in accordance with International patent practice. That is, the word does not preclude additional or unrecited elements, substances or method steps, in addition to those specifically recited. Thus, the described apparatus, substance or method may have other elements, substances or steps in various embodiments. The term “comprising” (and its grammatical variations) as used herein are used in the inclusive sense of “having” or “including” and not in the sense of “consisting only of”.

### BRIEF DESCRIPTION OF THE DRAWINGS

Notwithstanding any other forms which may fall within the scope of the present invention, example embodiments now be described, by way of example only, with reference to the accompanying drawings in which:

FIG. 1A illustrates an exploded view of the pour over vessel with a separated valve assembly and container.

FIG. 1B illustrates another exploded view of the pour over vessel with a separated valve assembly and container.

FIG. 1C illustrates a side view of an assembled pour over vessel.

FIG. 1D illustrates a rear view of an assembled pour over vessel.

FIG. 1E illustrates a top view of an assembled pour over vessel.

FIG. 2A illustrates a cross sectional view of the pour over vessel when the valve assembly is in a sealed position.

FIG. 2B illustrates a cross sectional view of the pour over vessel when the valve assembly is in a partially sealed position.

FIG. 2C illustrates a cross sectional view of the pour over vessel when the valve assembly is in an unsealed position.

FIG. 3 illustrates a system for making a beverage comprising a pour over vessel and a mobile communication device.

### DETAILED DESCRIPTION OF THE PREFERRED EMBODIMENTS

There are several commonly known devices and techniques of making coffee or tea using several devices. One technique of making these beverages involves brewing, in particular hand drip coffee brewing (also known as pour over) which is a technique for manually brewing coffee by hand. A common problem is that depending on the diameter of the spout and the degree of inclination of the kettle held by the coffee maker, a varied amount of hot water will be poured out from the spout. Such kettle designs are susceptible to burping spurts of water when the energy of the hot water in the kettle is released from the spout. The coffee is not brewed at an optimal water flow rate which may ruin the taste of the hand drip coffee.

The present invention relates to an improved pour over vessel that, in some example embodiments, may overcome one or more problems described earlier or provide the user with a useful alternative. The present invention relates to a vessel that comprises; a vessel chamber arranged to store a beverage; a spout portion arranged to communicate with the vessel chamber to release the beverage from the vessel chamber; and a valve assembly. The valve assembly comprises a valve member movable between a first position and a second position. The valve member at the first position permits a higher flow rate of beverage than the valve member at the second position. The valve assembly further comprises a control member operable by the user to control the position of the valve member. The presence of the user-controlled valve assembly helps to adjust the flow rate of the beverage expelled from the vessel and permits the beverage to be poured in a slow, better controlled quantities.

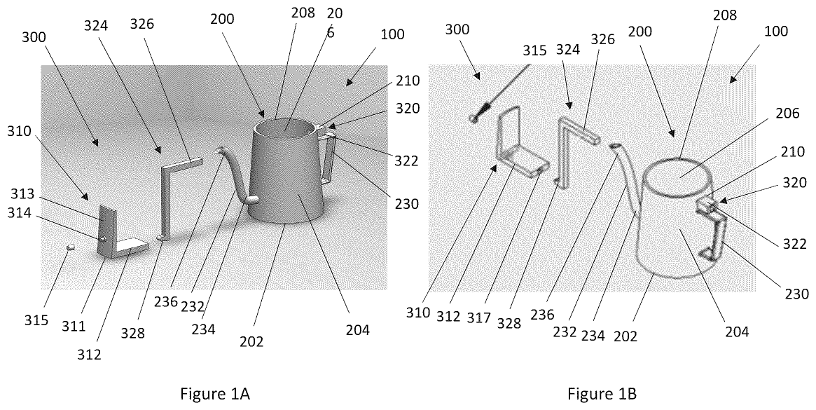

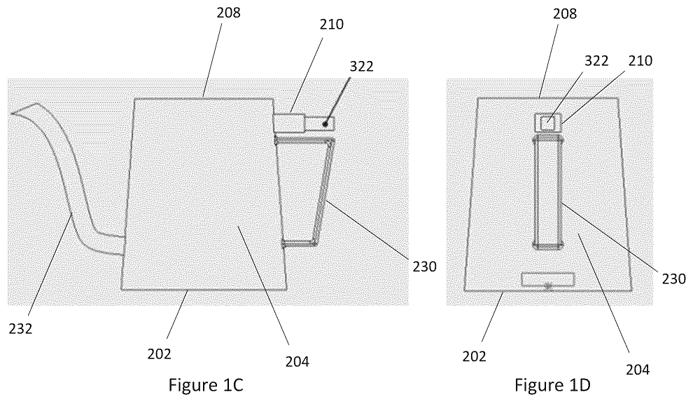

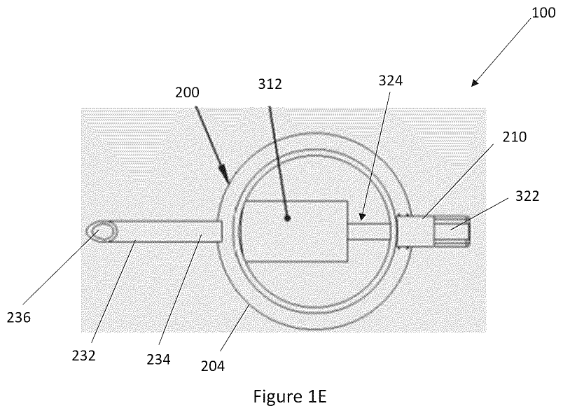

FIGS. 1A to 1E shows an example of a beverage making vessel 100. The beverage making vessel 100 is a pour over vessel. In one example the beverage making vessel 100 is an improved pour over vessel that may also be known as hand pour kettle, drip kettle, gooseneck kettle or other such terms. The beverage making vessel 100 can be used to make hot or cold beverages including, without limitations, coffee or tea or lemon water, fusion drinks, fruit tea or other beverages where the beverage is brewed through the dripping within a liquid in a separate container. Please note that the term “beverage” includes both the liquid used to make the beverage (e.g. water, (including tap water, mineral water, town water, bottled water, filtered water), milk, juice, coffee, tea pre-brewed drinks, partially brewed drinks) as well as the end beverage product consumed by a user. For the sake of simplicity and greater clarity, the beverage used to make the end beverage product will be described as liquid or potable liquid.

Referring to FIGS. 1A to 1E, the beverage making vessel 100 comprises a container 200 for storing a potable liquid and a valve assembly 300 for restricting the amount of liquid expelling from the container 200. The valve assembly 300 is inserted into and positioned within the vessel chamber of the container 200 throughout the operation. At least a portion of the valve assembly 300 extends out of the container 200 such that the valve assembly 300 can be operated by a user to activate and deactivate the valve assembly 300 respectively.

The valve assembly 300 is controllable by a user externally without directly contacting the valve assembly 300 through the vessel chamber of the container 200, which is normally at a high temperature as it contains a hot potable liquid. The valve assembly 300 can be formed by several components, with some of them being detachable such that they can be removed from the container 200 for rinsing.

As shown in FIGS. 1A to 1E, the container 200 comprises a base 202 and a wall 204 that extends upwardly from the base 202. The wall 204 defines the vessel chamber in the container 200 which is segregated into an upper segment and a lower segment. Liquid can be held within the vessel chamber of the container 200. The container 200 comprises an opening 206 at the top 208, wherein the top 208 is opposed to the base 202. Liquid can be poured into the vessel chamber defined by the wall 204 through the opening 206.

The container 200 comprises a generally cylindrical shape. The wall 204 has a circular shape in cross section. In this example embodiment, the container 200 comprises a generally pyramidal shape and in particular a frusto-conical shape. In this arrangement, the wall 204 is tapering sidewall that extends from the circular base 202 to the circular top 208. Preferably, the diameter of the circular base 202 is greater than the diameter of the circular top 208 such that the centre of gravity of the frusto-conical container 200 is at a position underneath half the height of the beverage making vessel 100.

In alternative forms, the container 200 may comprise a polygon prism shape. For example, the container 200 may be a hexagonal prism or a pentagonal prism or a rectangular prism or any other suitable shape. In these alternative forms, the wall 204 may comprise a polygon shape in cross section.

The container 200 may comprise a continuous single wall 204. Alternatively, the container 200 may comprise a plurality of walls that define the cylindrical shaped wall.

In the illustrated example the wall 204 is formed of stainless steel. The wall 204 may be formed from any other suitable material such as aluminium, copper, glass or a plastic material. On the rear end of the wall 204 there is provided an elongated tubular member 210 with an opening 212 so as to permit the insertion of at least some of the components of the valve assembly 300 into the container 200 through the wall 204.

In this example beverage making vessel 100, the liquid is boiled by another kettle before transferring into the vessel chamber of the container 200. In some other alternative forms, the kettle can be embedded with heating function. For instance, the beverage making vessel 100 is an electric kettle or an induction kettle. Once the liquid is locally heated within the beverage making vessel 100, the pouring of the liquid can be performed without transferring the heated liquid to another vessel.

Typically, it would take about three to four minutes to brew a cup of coffee by hand. The temperature of the liquid contained in the container 200 will drop from time to time during the brewing process. The keep-warm function may allow the user to brew several cups of coffee while still maintaining the water temperature within a threshold. It may also help to keep the water warm in a colder atmosphere.

In one alternative form, the container 200 may comprise a heat insulating function so as to maintain the liquid within a feasible temperature range. For instance, the wall 204 can be made of insulated structure such as double glass layers which provides an air gap between the two layers for keeping the liquid warm in the container 200.

Preferably, the container 200 comprises a handle 230. As shown in the illustrated embodiment of FIGS. 1A to 1E, the container 200 comprises a handle 230. The handle 230 is an arcuate shaped handle. The handle 230 may be formed from the same material as the container wall 204. Alternatively, the handle 230 may be formed from a different material e.g. wood, plastics material or any other suitable material. Preferably, the handle 230 is made of a thermally insulated material that reduces heat conduction from the container 200. This allows a user to hold the handle 230 even if the container 200 has a hot liquid without hurting the user.

The container 200 further comprises an opening spout 232 that helps a user to pour a liquid out of the container 200. In this example embodiment, the spout 232 is a thin, elongated curving gooseneck spout 232 which extends from an inlet portion 234 to an outlet portion 236 in a direction away from the container 200 and a through hole is formed along the spout 232. The inlet portion 234 is in a fluid communication with the lower segment of the container 200. The outlet portion 236 is in a fluid communication with the atmosphere. The amount of the liquid passing through the spout 232 depends on the annular space of the through hole in the spout 232.

Optionally, the container 200 may further comprise a lid (not shown). The lid is removably attached to the container 200. The lid is configured to form a closure on the container 200 and prevent liquid within the container 200 from spilling out and also preventing dirt or other contaminants from falling into the container 200. The lid is removably coupled to the top of the container 200.

When brewing a cup of coffee, it is very important to control the quantity of the hot water that is poured onto the coffee dripper and the time allowed for extracting the ingredients from the ground coffee. If the extraction time is too short, the brewed coffee would be watery and with a light coffee flavour. On the other hand, if the extraction time is too long, the brewed coffee would be too bitter and sour which is unlikely to be acceptable to average coffee drinkers.

In the illustrated example, the elongated spout 232 and the beverage making vessel 100 having a base 202 wider than the top 208 allow the user to regulate the water output from the pour-over kettle, so as to brew a cup of coffee with good flavour. During the brewing, the coffee maker grips the handle 230 and adjusts the angle of his wrist so as to expel the water from the container 200 and pour the water into the coffee dripper. To ensure that the water flow is consistent, the coffee maker has to maintain a constant wrist angle throughout the brewing.

To enhance the pouring over of liquid from the container 200 and in particular to allow the pouring to be more controllable, the valve assembly 300 is provided such that the liquid can be poured at a steadier rate, even if the wrist of the coffee maker wobbles slightly. This allows the user to easily pour the desired flow of water and to prevent the coffee grains from being unevenly infused, thus producing a coffee with a more consistent flavour.

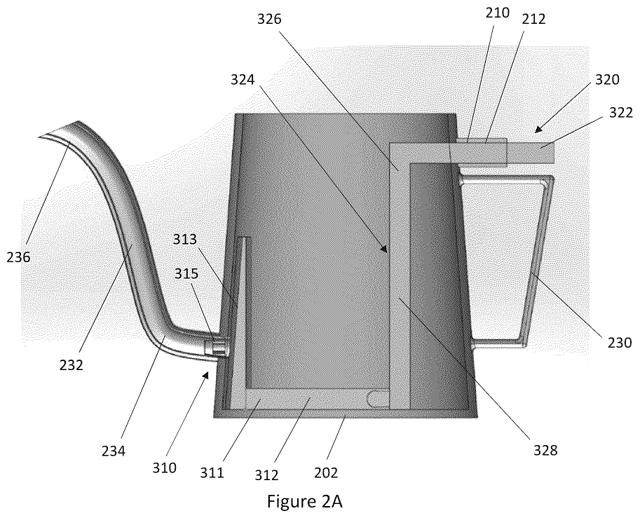

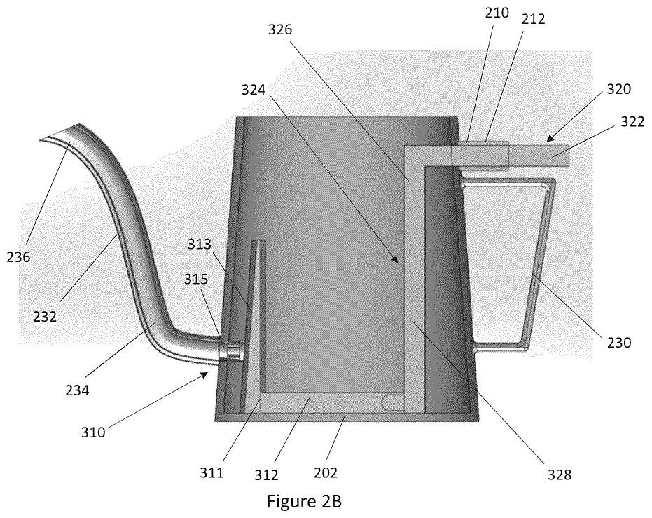

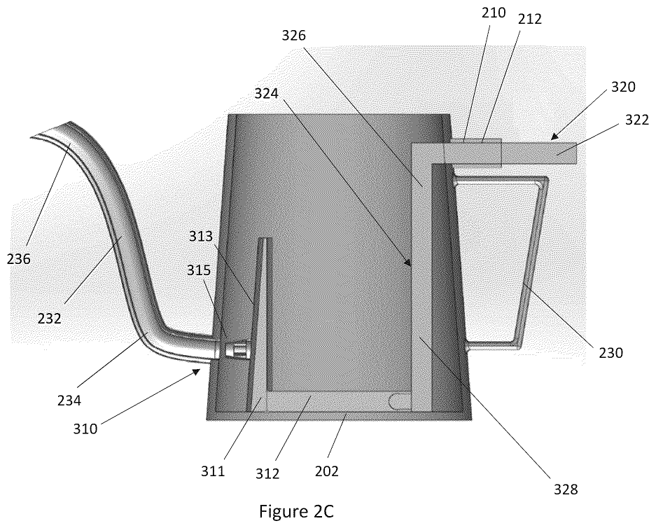

Referring to FIGS. 1A to 2C an example valve assembly 300 is illustrated. The valve assembly 300 comprises a valve member 310 and a control member 320 operable by the user to control the position of the valve member 320. By adjusting the control member 320, the valve member 310 can be movable between a plurality of positions so as to adjust the annular space of the through hole and the flow rate.

The valve member 310 may be integrated with the control member 320 or alternatively may be removably coupled to the control member 320. In one alternative form, the valve member 310 can be disassembled for easy cleaning and replacement of parts. The valve member 310 comprises a base member 311 which includes a horizontal base 312 resting on and being slidable along the container base 202. The base member 311 is further extended vertically in a direction perpendicular to the horizontal base 312 so as to provide a L-shape bracket with a planar surface 313 on which a protrusion 314 is provided. A plug portion 315 is detachably mounted to the protrusion 314.

The plug portion 315 includes a tapered portion so as to match the inner surface area of the spout inlet portion 234 i.e. the through hole. When the valve member 310 is moved to the sealing position as shown in FIG. 2A, the plug portion 315 covers the through hole completely and the fluid in the container 200 cannot be poured out from the spout 232 via the through hole. When the valve member 310 is moved to the semi-releasing position as shown in FIG. 2B, the plug portion 315 partially covers the through hole and the fluid in the container 200 can be poured out from the spout 232 via the through hole at a steady flow rate. When the valve member 310 is moved to the releasing position as shown in FIG. 2C, the plug portion 315 does not obstruct the through hole and the fluid in the container 200 can be poured out from the spout 232 via the through hole at a maximum and steady flow rate.

The illustrated example of the base member 311 further comprises a hole 317 on the rear end of the base member 311 so that the control member 320 can be attached to the trailing portion of the base member 311.

In one example embodiment, the control member 320 includes a push and pull button 322 on the rear end of the container 200 which is preferably proximate to the handle 230. In the illustrated example the push and pull button 322 is positioned above the handle 230. The push and pull button 322 extends through the opening 212 of the tubular member 210 to intercouple with the valve member 310 within the vessel chamber of the container 200.

The push and pull button 322 may be engaged to the container 200 by a push fit or press fit or friction fit. Optionally the contacting surface between the opening 212 and the push and pull button 322 may comprise a soft sealing structure e.g. an O ring that helps to seal the gap between the elongated tubular member 210 and push and pull button 322.

The push and pull button 322 and the valve member 310 are preferably connected by an additional linkage member 324. The illustrated example of the linkage member 324 has a first limb 326 coupled to the push and pull button 322. The linkage member 324 also has a second limb 328 coupled to the hole 317 on the horizontal base 312. In the illustrated example the linkage member 324 is a substantially invert L shaped. The first limb 236 is extended away from the push and pull button 322 and spans across the upper segment of the container 200, and the second limb 328 is further extended from the upper segment toward the lower segment in a direction perpendicular to the first limb 236 and spans across the depth of the container 200.

In an alternative form not shown in the diagram, the push and pull button 322 is provided on the rear side of the container 200 and underneath the handle 230. The linkage member 324 can be an elongated member extending horizontally from the push and pull button 322 towards the base member 311 and spans across the lower segment of the container 200.

In an alternative embodiment, the control member 320, the push and pull button 322 or the entire linkage member in connection with the base member 311, may be arranged to include a spring or resilient member such that the push and pull button may be resilient and return to an initial position after the push and pull button 322 is released from actuation by the user. This may be more tactile to the user as user may control the flow of water from the vessel with their finger pressing in one preferred direction only.

In an alternative embodiment, the control member 320 can be incorporated as a dial knob instead of push and pull button 322. The dial knob can convert the rotational movement into the linear movement of the control member 320 so as to move the valve member 310 between the sealing position and the releasing position.

In an alternative embodiment, the control member 320 can also be incorporated as a trigger button on the inner side of the handle 230. In this way, the coffee maker can grip the handle 230 while adjusting the position of the valve member 310 with a single hand.

In one embodiment, the push and pull button 322 or the dial knob can be provided with a scale graphically representing the corresponding flow rate of the spout 232. As an illustration, there can be provided on the push and pull button 322 a plurality of markings. A zero-flow rate marking is provided on one side of the push and pull button 322 and a maximum flow rate marking is provided on the other side of the push and pull button 322.

For instance, the zero-flow rate marking can be located further away from the tubular member 210 than the max flow rate marking.

In one example embodiment, the valve assembly 300 can further incorporate a motion sensor so as to monitor the position of the plug portion 315 and export such relevant info to an external device.

In one example embodiment, the container 200 can further comprises a timer for time recording and a flow meter to measure the flow rate of the liquid discharged from the spout 232 within a predetermine period.

In operation to make a beverage, particulates (e.g. ground coffee beans or tea leaves etc.) are added to a filter cone or filter bag. An additional cup is placed underneath the filter cone or filter bag. The flow rate of the spout 232 can be predefined by manually adjusting the position of the push and pull button 322. A liquid is then poured into the filter cone or filter bag in a controlled stream and mixed together to produce a desired drip of coffee in a cup.

Different brewing methods can be used to create different flavours of coffee, and the choice of brewing method will depend on the time required for brewing, the variety of beans and other factors. While the example embodiment of the vessel 100 is exemplified as a hand drip kettle, the beverage making vessel 100 can also be embodied as French press etc. For instance, there may be provided some interchangeable components that allow users to change the brewing method to suit different tastes and needs.

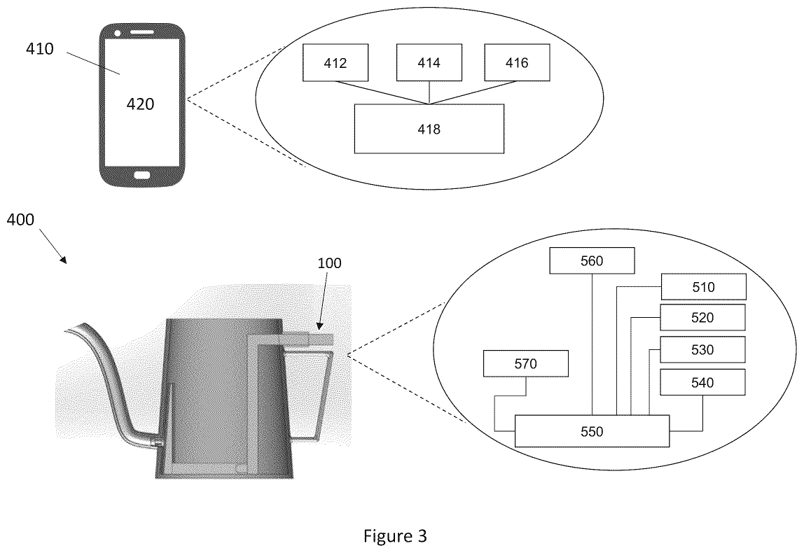

FIG. 3 shows a system 400 for making a beverage. The system 400 comprises a beverage making device 100 as described above and a mobile communication device 410. The mobile communication device 410 is a smartphone as shown in FIG. 3. Alternatively, the mobile communication device 410 may be a tablet or smartwatch or a wearable device. The mobile communication device 410 is in wireless communication with the beverage making device 100. The mobile communication device 410 comprises an image capturing module 412, a memory 414, a wireless communication module 416 (e.g. a Bluetooth module, Wi-Fi module etc.), a processor 418 and a graphical user interface 420.

FIG. 3 shows an example of the beverage making device 100 which may additionally include a valve motion sensor 510, a flow meter 520, a temperature sensor 530 and a load cell 540. The valve motion sensor 510 and the flow meter 520 may be mounted on the spout 232 of the container 200. The temperature sensor 530 and the load cell 540 may be mounted on the base 202 of the container 200.

The valve motion sensor 510 is configured to measure the position of the valve member 310, and the flow meter 520 is configured to measure the flow rate of the liquid discharged from the spout 232. The temperature sensor 530 is configured to measure the temperature of the contents of the container 200, and the load cell 540 is configured to measure contents within the container 200. The beverage making device 100 further comprises a processor 550, a wireless transceiver 560 and a memory unit 570. The sensor measurements may be configured to store sensor readings. The processor 550 is configured to receive and process signals from the sensors 510, 520, 530, 540. The wireless transceiver 560 is configured to transmit sensor signals to the mobile communication device 410.

The wireless transceiver 560 may be a Bluetooth module or a Wi-Fi module or a cellular communication module. The components illustrated schematically in FIG. 3 are understood to be internal to the mobile communication device 400 and/or to the beverage making device 100. These components are implemented on PCBs with appropriate electronic components.

The mobile communication device 410 comprises a software application that is stored in its memory 414 and executed by the processor 418. The application when executed causes the mobile communication device 410 to execute a method of making a beverage. A particular beverage may be selected from a plurality of pre-stored specie of coffee beans.

The mobile communication device 410 can store multiple beverage recipes associated with different species of coffee beans. The application automatically calculates an optimal water flow rate and the requisite time for a selected specie of coffee beans. For example, for a particular specie of coffee beans the optimal water flow rate and requisite time are presented to the user on the graphical user interface (GUI) 420. The various species of coffee beans may be stored in memory 414.

For instance, a user is requested to input a cup size, the number of servings can be input, the specie of the coffee bean, a coarseness of the ground and the required flavour are requested. The user can input these via graphical indicia or buttons or via the GUI.

Alternatively, the image capturing module 412 of the device 410 may capture the coffee powder or coffee packaging so as to scan the information of the coffee beans or powder.

Once these parameters are received, the device 410 automatically calculates the desirable flow rate of the water, requisite time and an ideal temperature. The device 410 can also suggest the corresponding setting of the valve assembly 300.

This information is presented on the GUI 420. Favourite recipes can be stored in the memory 414 by pressing the virtual “save recipe” button. Custom recipes may also be created.

The position of the valve member 310 is determined by the valve motion sensor 510. A graphical indicator is presented on the GUI 420 so as to show the user the desirable position of the plug portion 315. The flow rate of the liquid from the spout 232 is also measured by the flow meter 520. Optionally an alarm, e.g. an audible and/or visual alarm, may be raised and presented on the GUI 420 if the position of the valve member 310 and the flow rate deviates from the recommended configuration i.e. a referential valve position.

The amount of liquid (e.g. water) added to the container 200 and expelled from the container 200 are measured by the load cell 530. A scale indicator is filled to visually show the amount of liquid added and expelled. An alarm may be raised and presented on the GUI 420 if the volume of the expelled liquid measured is greater than the required volume of liquid for coffee brewing. The temperature of the contents of the container 200 are measured by the temperature sensor 540 and presented on the GUI 420. The real time temperature is presented in a temperature indicator. The temperature may be updated in real time or substantially real time based on information received at the mobile communication device 400 from the beverage making device 100.

A timer can also be presented on the GUI 420. The timer may count to the requisite time. The requisite time may be pre-set based on the stored recipe. An alarm may be raised when the time has exceeded the requisite time. The temperature indicator may also be presented in conjunction to the timer. The timer relates to the amount of time the particulates (i.e. solids) are required to be steeped in the liquid to make the selected beverage.

Once the requisite time has been reached, a message is presented on the GUI 420. The message indicates that the pouring needs to be terminated.

The method of making a beverage and system for making a beverage is advantageous because the software application provides a step by step method of making beverage. The optimal flow rate and requisite time are calculated and presented, avoid guess work. The consistency of the water flow rate is better controlled thereby making the beverage more accurately. This provides improved taste and reduces approximations required by a user. The flow rate and temperature are also measured in real time and therefore provides an improved beverage making process. The beverage making process helps to make a tastier beverage and provides a simplified step by step method for making beverages. The taste of multiple coffees become more repeatable.

The method provides the parameters required to make a specific beverage. The described method is advantageous because it removes the guess work when trying to make the beverage. The method and system provide an optimal flow rate and requisite time to make a beverage. This again simplifies the beverage making process and allows for a more tasty beverage.

The description of any of these alternative embodiments is considered exemplary. Any of the alternative embodiments and features in the alternative embodiments can be used in combination with each other or with the embodiments described with respect to the figures.

The foregoing describes only a preferred embodiment of the present invention and modifications, obvious to those skilled in the art, can be made thereto without departing from the scope of the present invention. While the invention has been described with reference to a number of preferred embodiments it should be appreciated that the invention can be embodied in many other forms.

The invention claimed is:

1. A vessel comprising:
a vessel chamber arranged to store a beverage or a potable liquid;
a spout portion arranged to communicate with the vessel chamber to release the beverage or the potable liquid from the vessel chamber;
a valve assembly comprising
a valve member movable between a first position and a second position,
wherein the valve member at the first position permits a higher flow rate of the beverage or the potable liquid from the vessel chamber than the valve member at the second position; and
a control member operable by the user to control the position of the valve member.

2. A vessel in accordance with claim 1, wherein the expel of the beverage or the potable liquid is at a maximum flow rate when the valve member is at the first position.

3. A vessel in accordance with claim 1, wherein the expel of the beverage or the potable liquid is blocked by the valve member when the valve member is at the second position.

4. A vessel in accordance with claim 1, wherein the valve member is movable between multiple positions and adjustable by the user whereby the vessel is operable to expel the beverage or the potable liquid at various flow rates.

5. A vessel in accordance with claim 1, wherein the valve member includes a plug portion arranged to be movable in a direction substantially parallel to the flow direction of the beverage or the potable liquid at an inlet of the spout portion in communication with the vessel chamber.

6. A vessel in accordance with claim 5, wherein the plug portion includes a tapered portion.

7. A vessel in accordance with claim 1, wherein the control member is disposed outside the vessel chamber and accessible by the user on the outer wall of the vessel.

8. A vessel in accordance with claim 1, wherein the control member includes a push and pull button arranged such that the valve member is movable towards the inlet of the spout portion when the button is in a depressed position.

9. A vessel in accordance with claim 1, further comprising a handle, and the control member is at a position proximate to the handle whereby the handle and the control member are both accessible by the same hand of the user.

10. A vessel in accordance with claim 1, wherein the valve assembly further includes a linkage with its one end connected to the valve member and the opposite end connected to the control member.

11. A vessel in accordance with claim 10, wherein at least a portion of the linkage is extended along a first direction being substantially parallel to the spout direction and extended further along a second direction being substantially perpendicular to the first direction.

12. A vessel in accordance with claim 1, wherein the vessel chamber further comprises a tubular member with an opening through which at least a portion of the control member disposed outside the vessel chamber is insertable into the vessel chamber.

13. A vessel in accordance with claim 1, wherein the valve assembly further includes a base member on which the valve member is mounted.

14. A vessel in accordance with claim 1, wherein the base member is slidably movable along the base of the vessel.

15. A system for making a beverage or a potable liquid, the system comprising:
a vessel comprising:
a vessel chamber arranged to store a beverage or a potable liquid;
a spout portion arranged to communicate with the vessel chamber to release the beverage or the potable liquid from the vessel chamber;
a valve assembly comprising
a valve member movable between a first position and a second position, wherein the valve member at the first position permits a higher flow rate of the beverage or the potable liquid from the vessel chamber than the valve member at the second position; and
a control member operable by the user to control the position of the valve member;
one or more sensors associated with the vessel, the sensors configured to determine information associated with the flow rate of the beverage or the potable liquid;
a wireless communication transceiver configured to transmit signals from the one or more sensors;
a mobile communication device comprising a processor, a memory, graphical user interface and a wireless communication interface;
the mobile communication device configured to receive sensor readings from the one or more sensors wirelessly via the wireless communication interface.

16. A system in accordance with claim 15, further comprising a motion sensor configured to determine one or more information associated with the position of the valve member relative to the spout portion.

17. A system in accordance with claim 16, further comprising an indication unit configured to inform the user when the position of the valve member is offset from a referential valve position.

18. A system in accordance with claim 15, wherein the processor is configured to determine the optimal flow rate of the beverage or the potable liquid released from the spout portion associated with the making of a selected beverage.

19. A system in accordance with claim 18, wherein the mobile communication device further comprises an image capturing module configured to determine the identity of a selected beverage.

20. A system in accordance with claim 15, further comprising an indication unit configured to inform the user upon the amount of the beverage or the potable liquid released from the spout portion within a predetermined period exceeds a predetermined volume threshold.
